(19) United States
(12) Patent Application Publication
(10) Pub. No.: US 2008/0294764 A1
(43) Pub. Date: Nov. 27, 2008

(54) STORAGE MEDIUM BEARING HBA INFORMATION PROVISION PROGRAM, HBA INFORMATION PROVISION METHOD AND HBA INFORMATION PROVISION APPARATUS

(75) Inventor: Toshinori Wakako, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/124,585

(22) Filed: May 21, 2008

(30) Foreign Application Priority Data
May 21, 2007 (JP) 2007-133852

(51) Int. Cl. G06F 15/173; G06F 9/54; G06F 9/44

(52) U.S. Cl. 709/223; 719/321; 719/331

(57) ABSTRACT

A storage medium bears a program which controls a plurality of HBA drivers for controlling operations of a plurality of HBAs connected to a few storage devices through a SAN, a plurality of specific libraries in an SNIA HBA API, each having a function of acquiring information on the corresponding HBA, from the corresponding HBA driver as HBA information, and a common library in the SNIA HBA API, having a function of acquiring HBA information from the respective specific libraries, thereby to acquire the HBA information items and to provide them to a SAN management manager.

### BACKGROUND OF THE INVENTION

The present invention relates to a storage medium which bears a program for acquiring HBA (Host Bus Adapter) information and providing the information to a SAN (Storage Area Network) management manager, an HBA information provision method and an HBA information provision apparatus.

### DESCRIPTION OF THE RELATED ART

As is well known, a SAN is a network for communicably connecting a job server machine and a storage device. Here, the job server machine is a server for providing any function to a computer in an external network, such as database server, streaming server, Web server or application server, while the storage device is a device for storing data which the job server machine provides to the computer in the external network.

FIG. 7 is an architectural diagram of a computer network system to which the SAN is applied. In the computer network system shown in FIG. 7, a job server machine 10 is connected to an external network N through, for example, a LAN (Local Area Network) adapter 10b, and it is also connected to storage devices 20 through the SAN. This SAN is built of communication means conforming to an interface standard termed “Fibre Channel”.

The structure of the communication means is described below. In all of the job server machine 10 and the storage devices 20, HBAs 10a and 20a are mounted as communication interfaces for the SAN. The HBAs 10a and 20a are directly connected, or are indirectly connected through well-known fibre channel switches not shown. The HBAs 10a and 20a and the fibre channel switches not shown are interconnected by, for example, optical fibre cables.

In addition, an application 11 for providing any function to a computer in the external network N accesses the storage device 20 through a file system, a multipath driver, an HBA driver and the HBA 10a in well-known fashion, though these constituents are not shown.

Besides, there has been developed software 30 for managing the SAN configured as stated above. In general, the SAN management software 30 is constituted by a SAN management agent 30a, a SAN management manager 30b and a SAN management client 30c as shown in FIG. 7.

Among them, the SAN management manager 30b and the SAN management client 30c are respectively installed and used in computers 40 and 50 (SAN management server machine 40 and SAN management client machine 50) which are LAN-connected to the job server machine 10 through LAN adapters 10c, 40a and 50a. In addition, the SAN management manager 30b includes a module program which collects information on the SAN through the SAN management agent 30a to be stated below and which accumulates the information therein, and a module program which provides the accumulated information to the SAN management client 30c as browse information, in compliance with a request made by the SAN management client 30c.

On the other hand, the SAN management agent 30a is a program which is installed and used in the job server machine 10. It includes a module program which collects a model name, a manufacturer name, a WWPN (World Wide Port Name) and the like information on the HBAs 10a, as HBA information, and a module program which collects information on the states of the inputs/outputs of data to/from the storage devices 20 by the HBA drivers.

FIG. 8 is a diagram showing various functions for incarnating the collection of the HBA information. As shown in FIG. 8, the job server machine 10 is a general-purpose computer which includes the HBA 10a, the LAN adapters 10b and 10c, a storage unit 10d, a CPU (Central Processing Unit) 10e, and a memory unit 10f. The application 11, operating system software 12, and the SAN management agent 30a are stored in the storage unit 10d.

Among them, the operating system software 12 is software for providing basic functions such as the managements of the inputs/outputs of data in the communication adapters 10a to 10c and the managements of the storage areas of the storage unit 10d and the memory unit 10f, to many applications including the application 11. In the operating system software 12, the HBA driver 31 and an SNIA (Storage Networking Industry Association) HBA API (Application Program Interface) are mounted (incorporated). Among them, the HBA driver 31 is a program for controlling the operation of the HBA 10a, and it is mounted in the operating system software 12 when the HBA 10a has been attached to the job server machine 10. On the other hand, the SNIA HBA API is an API for the HBA 10a as conforms to a standard which has been stipulated by a standardization organization named “SNIA”, in order to save the labor of programming in the development of the SAN management software 30. This SNIA HBA API includes a specific library 32 and a common library 33. Of them, the specific library 32 is a component group (classes, components and functions) for the SAN management agent 30a created on the basis of peculiar specifications which a manufacturer source has set for the HBA 10a produced by itself, and it is mounted in the operating system software 12 when the HBA 10a has been attached to the job server machine 10. On the other hand, the common library 33 is a component group for the SAN management agent 30a created on the basis of common specifications which do not depend upon the difference of the manufacturer source of the HBA 10a, and it is mounted in the operating system software 12 when the HBA 10a has been attached to the job server machine 10, or it is mounted as a standard file in the operating system software 12 beforehand. Incidentally, FIG. 8 shows a state where the HBA driver 31 and both the libraries 32 and 33 are expanded in the memory unit 10f.

On the other hand, the SAN management agent 30a includes an MBA information acquisition module 39. The HBA information acquisition module 39 is a program which is run when triggered by an instruction from the SAN management manager 30b.

After the start of a process, the HBA information acquisition module 39 (or the CPU 10e executing this module) loads the common library 33, and it invokes a function termed “HBA_GetAdapterAttributes( )”, from within the common library 33. Then, the function loads the specific library 32 defined in an unshown list file within the common library 33, and it acquires the HBA information of the HBA 10a from the specific library 32 so as to deliver the HBA information to the HBA information acquisition module 39. When the HBA information acquisition module 39 accepts the HBA information, it delivers the HBA information to the SAN management manager 30b.

Meanwhile, the transfer rate of the interface of the storage device 20 is recently shifting from 2 Gbps to 4 Gbps, and some examples in which the storage device 20 supporting the transfer rate of 4 Gbps is additionally introduced into the SAN have been seen. In the examples, the HBA 10a supporting the transfer rate of 4 Gbps is additionally introduced into the job server machine 10. In such a case, the manufacturer source of the HBA 10a to be additionally introduced into the job server machine 10 is sometimes different from the manufacturer source of the HBA 10a already mounted. By the way, in a case where the HBA 10a of the manufacturer source different from the HBA 10a already mounted is additionally introduced into the job server machine 10, the HBA driver 31 and the specific library 32 prepared by the different manufacturer source must be additionally introduced into the job server machine 10.

In a case where, for such reasons, the job server machine 10 includes the HBA 10a-(a) of a manufacturer source (a) and the HBA 10a-(b) of a manufacturer source (b) as shown in FIG. 9, the above function “HBA_GetAdapterAttributes( )” within the common library 33 loads all specific libraries 32-(a) and 32-(b) defined in the unshown list file within the common library 33. Thereafter, the function first acquires the HBA information of the HBA 10a-(a) through the specific library 32-(a) prepared by the manufacturer source (a), and it subsequently acquires the HBA information of the HBA 10a-(b) through the specific library 32-(b) prepared by the manufacturer source (b).

Here, the job server machine 10 may possibly include, at most, three common libraries among the common library prepared by the manufacturer source (a), the common library prepared by the manufacturer source (b) and the common library mounted as the standard file in the operating system software 12 beforehand. In a standard stipulated by the SNIA. However, only one common library 33 must be loaded in the memory unit 10f. This is because the common library 33 is standardized to be a component group which can be utilized irrespective of the difference of the manufacturer source. Therefore, without regard to the manufacturer source of the common library 33, the function “HBA_GetAdapterAttributes( )” within the loaded common library ought to be capable of acquiring the HBA information of all the HBAs 10a through the respective specific libraries 32 irrespective of the difference of the manufacturer sources of the HBAs 10a.

As an actual problem, however, in a case where the manufacturer source of the common library 33 (for example, the manufacturer source (a)) and the manufacturer source of the specific library 32 (for example, the manufacturer source (b)) are different, the function “HBA_GetAdapterAttributes( )” within the common library 33 has been sometimes incapable of acquiring the HBA information from the specific library 32. This is caused by differences of installation which are ascribable to room for interpretation of the SNIA standard. Accordingly, the SAN management agent 30a has sometimes failed to provide the HBA information of all the HBAs 10a mounted in the job server machine 10, to the SAN management manager 30b.

### SUMMARY

A storage medium bearing an HBA information provision program as proposed in order to solve the above problem is a storage medium bearing a program which controls a plurality of HBA drivers for controlling operations of a plurality of HBAs connected to a few storage devices through a SAN, a plurality of specific libraries in an SNIA HBA API, each having a function of acquiring information on the corresponding HBA, from the corresponding HBA driver as HBA information, and a common library in the SNIA HBA API, having a function of acquiring HBA information from the respective specific libraries, thereby to acquire the HBA information items and to provide them to a SAN management manager. The program causes a computer to function as follows: (a) storage means for storing records in each of which model identification information specifying a model and common library identification information specifying the common library suited to acquire the HBA information from the HBA of the model are associated, in a definition table for respective models of the HBAs; (b) switch means for loading any common library into a memory and switching common libraries loaded in the memory, in succession one by one, when a predetermined instruction has been received from the SAN management manager through a communication device; (c) acquisition means for requesting all the specific libraries to send the HBA information and acquiring the HBA information from the few specific libraries, each time the switch means has loaded one common library into the memory; (d) discrimination means for discriminating whether or not the record which contains a combination of the model information contained in the HBA information and the common library identification information of the common library in the memory is recorded in the definition table, for every acquired HBA information when the acquisition means has acquired the HBA information; (e) retention means for retaining the HBA information relevant to the combination, in a predetermined area of the memory in a case where the discrimination means has determined that the record containing the combination is recorded in the definition table; and (f) transmission means for transmitting all the HBA information items which the retention means has retained in the predetermined area, to the SAN management manager through the communication device.

Owing to such a configuration, the computer loads the plurality of common libraries in succession and executes the process for acquiring the HBA information items through all the specific libraries, as to the common library being loaded. The computer delivers to the SAN management manager only those of the few acquired HBA information items which contain the model identification information associated with the identification information of the common library being loaded, for inclusion in the definition table. Thus, even in a case where one fixed common library is included and where the HBA information of any HBA 10a sometimes fails to be acquired on account of the inferior combination of the common library and any specific library 32, the HBA information of the HBA 10a can be acquired from the specific library 32 through another common library 33.

### BRIEF DESCRIPTION OF THE DRAWINGS

FIG. 1 shows a block diagram of a job server machine in an embodiment of the present invention;

FIG. 2 shows an example of the data structure of a common library management table;

FIG. 3 shows an example of the data structure of a definition table;

FIG. 4 shows the flow of a process based on an HBA information acquisition module;

FIG. 5 shows an example of the data structure of a work table;

FIG. 6 shows the flow of a process based on the optimal HBA information extraction subroutine;

FIG. 7 shows an architectural diagram of a computer network system to which a SAN is applied; and

FIGS. 8 and 9 show various functions for incarnating the collection of HBA information.

### DETAILED DESCRIPTION OF THE EMBODIMENT

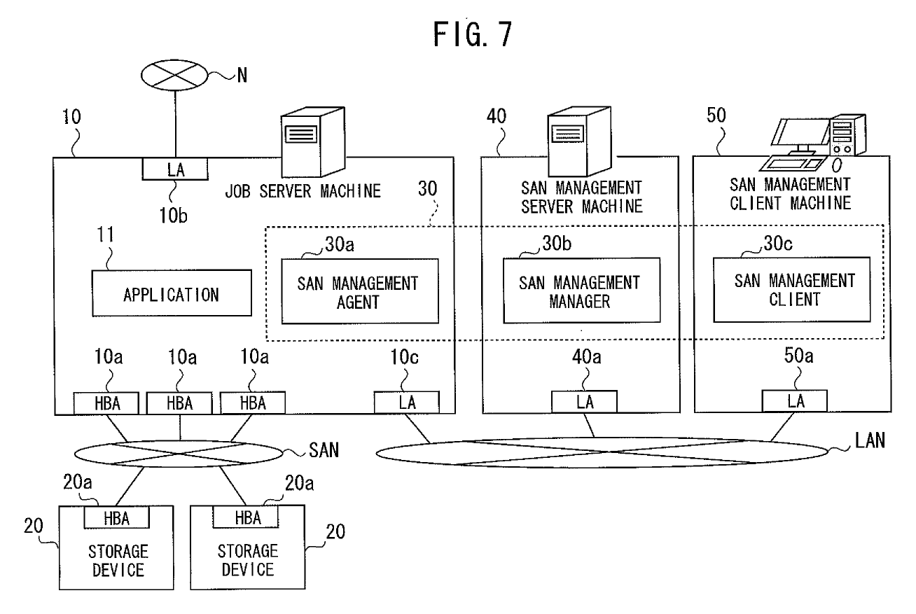

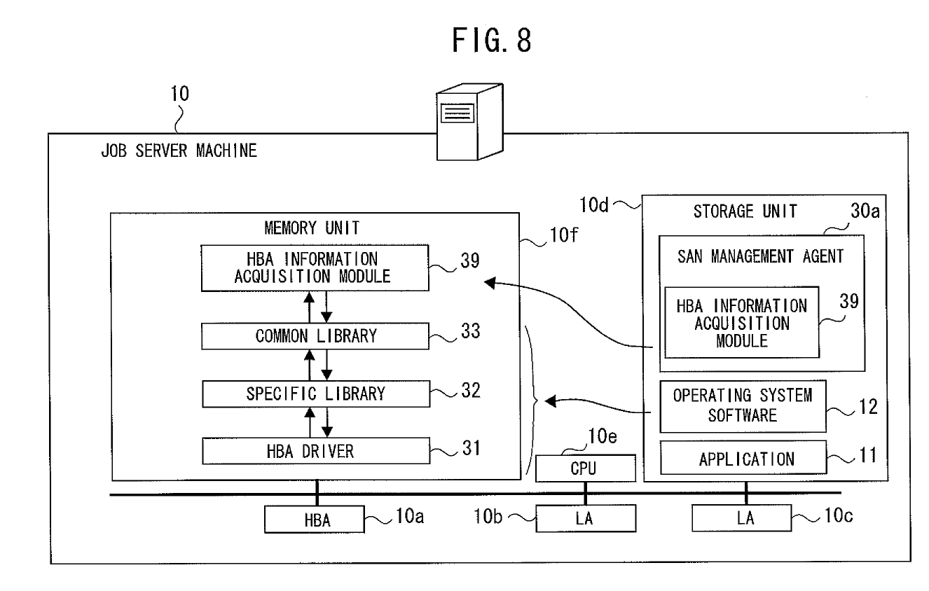

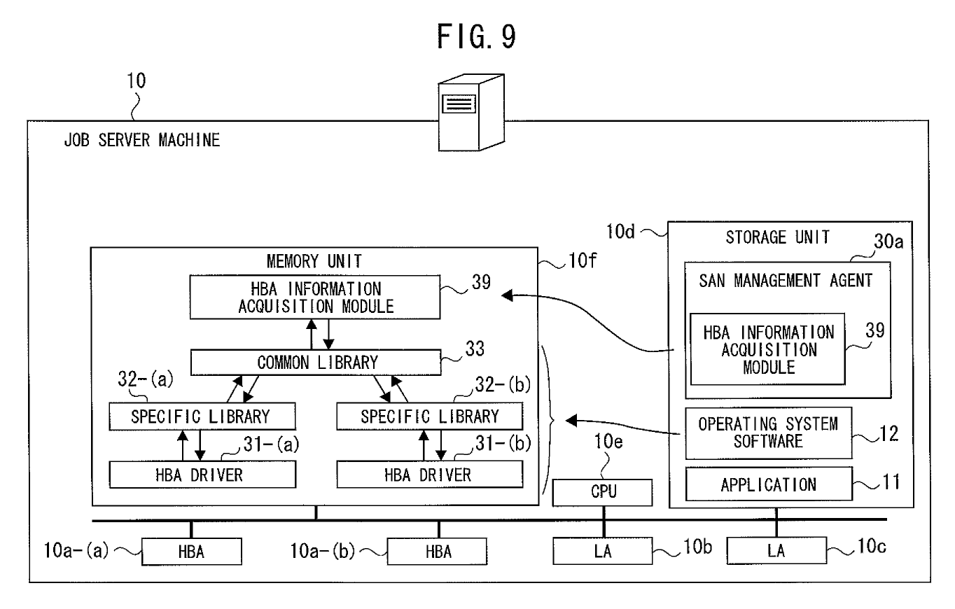

Now, an aspect in which the present invention is applied to the job server machine constituting the computer network system shown in FIG. 7 will be described with reference to the drawings.

Incidentally, the job server machine 10 in this embodiment uses the computer network system in FIG. 7. As stated before, therefore, the job server machine 10 is SAN (Storage Area Network)-connected to the storage device 20 through the HBA (Host Bus Adapter) 10a, and it is also connected to the external network N through, for example, the LAN (Local Area Network) adapter 10b. Besides, the job server machine 10 is LAN-connected to the SAN management server machine 40 and the SAN management client machine 50 through the LAN adapter 10c. In addition, the SAN management manager 30b and the SAN management client 30c which constitute the SAN management software 30 are respectively installed in the SAN management server machine 40 and the SAN management client machine 50.

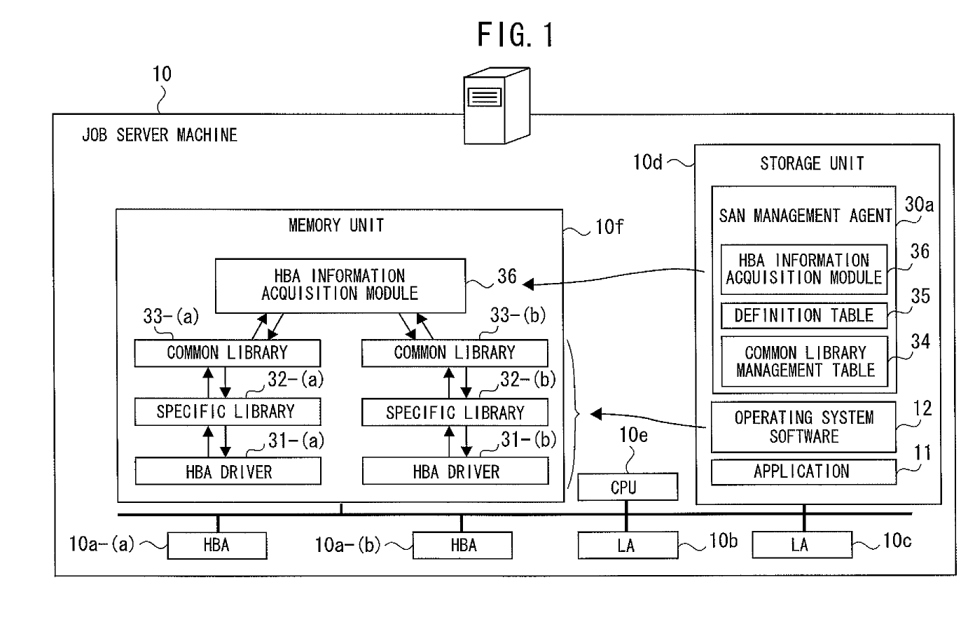

FIG. 1 is a block diagram of the job server machine 10 in this embodiment. As shown in FIG. 1, the job server machine 10 is a general-purpose computer which includes HBAs 10a, LAN adapters 10b and 10c, a storage unit 10d, a CPU (Central Processing Unit) 10e, and a memory unit 10f. Among them, the HBAs 10a are a communication interface for exchanging data with a computer in the SAN. By the way, in the ensuing description, in a case where a manufacturer source need not be distinguished, the HBA shall be denoted as 10a, and in a case where a manufacturer source needs to be distinguished, the HBA produced by, for example, a manufacturer source (a) shall be denoted as 10a-(a). Each of the LAN adapters 10b and 10c is a communication interface for exchanging data with a computer in the LAN. The storage unit 10d is a unit for recording various programs and data therein. The CPU 10e is a unit which executes processes in accordance with the programs recorded in the storage unit 10d. The memory unit 10f is a unit in which the programs and data are cached, and in which a work area for the CPU 10e is expanded.

Besides, the job server machine 10 stores an application 11, operating system software 12 and a SAN management agent 30a in the storage unit 10d.

Among them, the operating system software 12 is software for providing basic functions such as management of the inputs/outputs of data in the communication adapters 10a to 10c and management of the storage areas of the storage unit 10d and the memory unit 10f, to many applications including the application 11. In the operating system software 12, HBA drivers 31 and SNIA (Storage Networking Industry Association) HBA APIs (Application Program Interfaces) are mounted (incorporated). Among them, the HBA driver 31 is a program for controlling the operation of the HBA 10a. By the way, in the ensuing description, in a case where a manufacturer source need not be distinguished, the HBA driver shall be denoted as 31, and in a case where a manufacturer source needs to be distinguished, the HBA driver created by, for example, a manufacturer source (b) shall be denoted as 31-(b). The HBA driver 31-(a) is mounted in the operating system software 12 when the HBA 10a-(a) has been attached to the job server machine 10, while the HBA driver 31-(b) is mounted in the operating system software 12 when the HBA 10a-(b) has been attached to the job server machine 10. On the other hand, the SNIA HBA API for the HBA 10a conforms to a standard which has been stipulated to by a standardization organization named “SNIA”, in order to save the labor of programming in the development of SAN management software 30. This SNIA HBA API includes a specific library 32 and a common library 33. Of them, the specific library 32 is a component group (classes, components and functions) for the SAN management agent 30a created on the basis of peculiar specifications which the manufacturer source has set for their own HBA 10a. By the way, in the ensuing description, in a case where the manufacturer source need not be distinguished, the specific library shall be denoted as 32, while in a case where the manufacturer source needs to be distinguished, the specific library created by, for example, the manufacturer source (a) shall be denoted as 32-(a). The specific library 32-(a) is loaded in the operating system software 12 when the HBA 10a-(a) has been attached to the job server machine 10, while the specific library 32-(b) is mounted in the operating system software 12 when the HBA 10a-(b) has been attached to the job server machine 10. On the other hand, the common library 33 is a component group for the SAN management agent 30a created on the basis of common specifications which do not (ought not) depend upon the difference of the manufacturer source of the HBA 10a, and it is mounted in the operating system software 12 when the HBA 10a has been attached to the job server machine 10, or it is mounted as a standard file in the operating system software 12 beforehand. Here, the common library 33-(a) is a common library created by the manufacturer source (a), while the common library 33-(b) is a common library created by the manufacturer source (b). Incidentally, FIG. 1 shows a state where the MBA drivers 31-(a) and 31-(b) and both libraries 32-(a) as well as 32-(b) and 33-(a) as well as 33-(b) are expanded in the memory unit 10f.

On the other hand, the SAN management agent 30a includes a common library management table 34, a definition table 35 and an HBA information acquisition module 36.

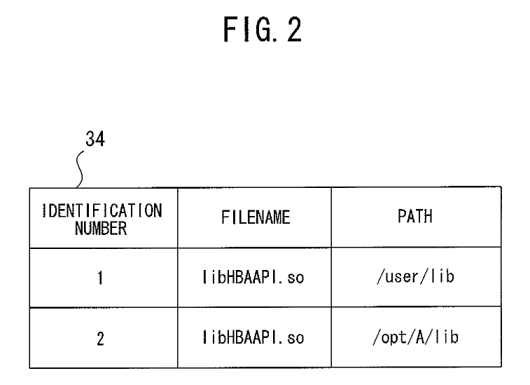

FIG. 2 is a diagram showing an example of the data structure of the common library management table 34. The common library management table 34 shown in FIG. 2 has records which are equal in number to the records of the common library 33. Each record has the fields of an “identification number”, a “filename” and a “path”. The “identification number” field is a field in which the identification number for uniquely specifying the pertinent common library is recorded. The “filename” field is a field in which the filename of the common library is recorded. The “path” field is a field in which the path being positional information that is logically defined for the storage location of the common library in an unshown file system within the operating system software 12 is recorded.

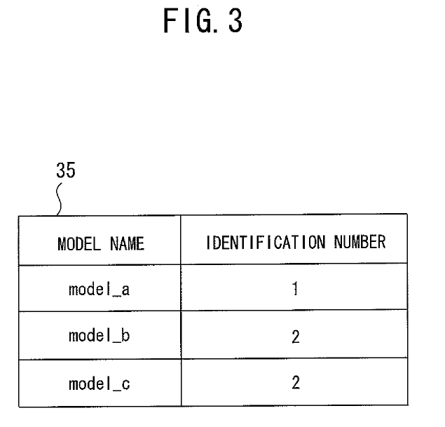

FIG. 3 is a diagram showing an example of the data structure of the definition table 35. The definition table 35 shown in FIG. 3 has records which are equal in number to the models of the HBA 10a installed in the job server machine 10. Each record has the fields of a “model name” and an “identification number”. The “identification number” field is a field in which the designation of the model is recorded. The “identification number” field is a field in which the identification number of the optimal common library 33 for acquiring information on the HBA of the model, as HBA information is recorded. Incidentally, the HBA information is information on the HBA 10a, such as the model name, a manufacturer name and a WWPN (World Wide Port Name).

Incidentally, the job server machine 10 in which the combination of the model name and the identification number is stored in the definition table 35 corresponds to the storage means stated before and the storage unit stated before. Besides, it corresponds to the storage step described before in which the job server machine 10 stores the combination of the model name and the identification number in the definition table 35.

The HBA information acquisition module 36 in FIG. 1 is a module program for acquiring the HBA information by controlling the HBA driver 31, the specific library 32 and the common library 33. This HBA information acquisition module 36 is run by the CPU 10e when triggered by an instruction from a SAN management manager 30b in a SAN management server machine 40.

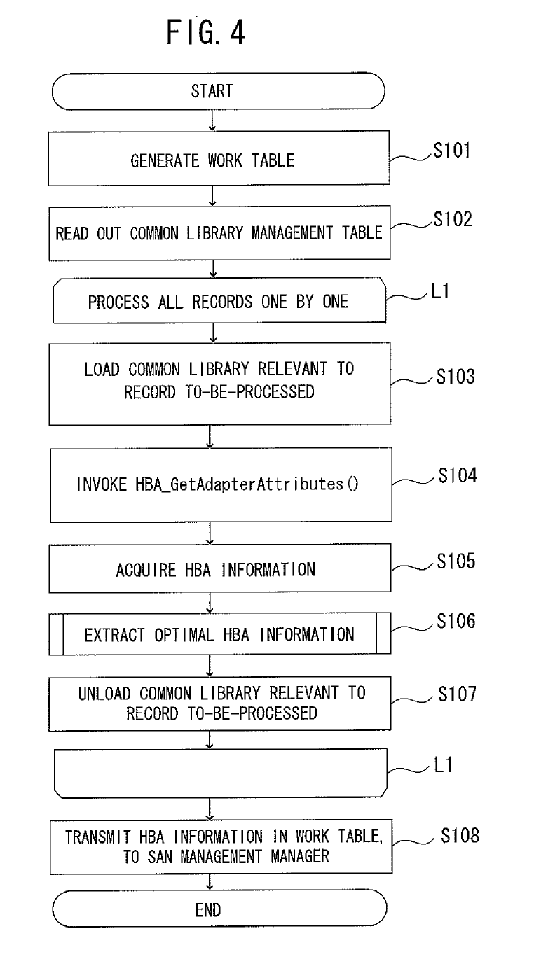

FIG. 4 is a diagram showing the flow of a process based on the HBA information acquisition module 36. As shown in FIG. 4, after the start of the process, the HBA information acquisition module 36 (or the CPU 10e executing this module) generates a work table in the memory unit 10f at the first step S101. Incidentally, the work table is a table for recording therein the HBA information of all the HBAs 10a mounted in the job server machine 10.

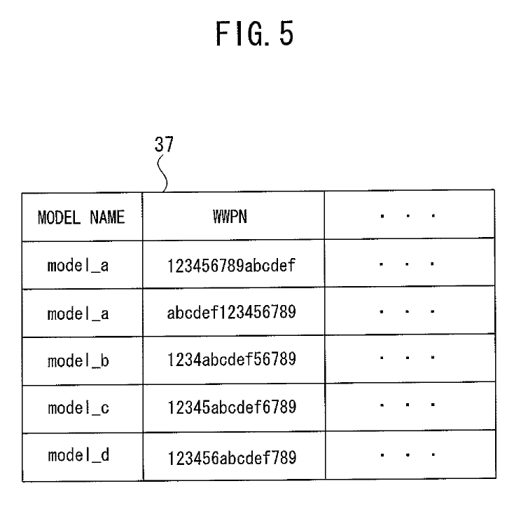

FIG. 5 is a diagram showing an example of the data structure of the work table 37. As shown in FIG. 5, each record of the work table 37 has the fields of a “model name”, a “WWPN”, . . . . The “model name” field is a field in which the model name of the HBA is recorded. The “WWPN” field is a field in which the WWPN of the HBA is recorded. Incidentally, the HBA information which is obtained from the specific library 32 by using a function “HBA_GetAdapterAttributes( )” within the common library 33 contains a large number of information items other than the model name and the WWPN. Therefore, the work table 37 also has many fields other than the fields for recording the model name and the WWPN therein, but the other fields need not be specifically indicated in FIG. 5.

At the step S101 in FIG. 4, the HBA information acquisition module 36 generates the work table 37 as shown in FIG. 5. Immediately after the step S101, however, no record exists in the work table 37. That is, at the step S101, the HBA information acquisition module 36 merely generates the novel work table 37 in the memory unit 10f.

At the next step S102, the HBA information acquisition module 36 reads out the common library management table 34 in FIG. 2. Thereafter, the HBA information acquisition module 36 executes the first processing loop L1.

In the first processing loop L1, the HBA information acquisition module 36 executes the processing of steps S103 to S107 for all the records in the common library management table 34 read out at the step S102, one by one.

At the step S103, the HBA information acquisition module 36 loads the common library 33 (for example, the common library 33-(a)) pertinent to the record to-be-processed (or fetches the common library 33 into the memory unit 10f).

At the next step S104, the HBA information acquisition module 36 invokes the function “HBA_GetAdapterAttributes( )” within the common library 33 loaded at the step S103. Incidentally, when invoked, the processor loads all the specific libraries 32-(a) and 32-(b) defined in an unshown list file within the common library 33, and it acquires the HBA information of all or some of the HBAs 10a mounted in the job server machine 10, from both or one of the specific libraries 32-(a) and 32-(b), so as to deliver the acquired HBA information to the HBA information acquisition module 36.

At the next step S105, the HBA information acquisition module 36 waits until it accepts the HBA information from the function “HBA_GetAdapterAttributes ( )” invoked at the step S103. In addition, when the HBA information acquisition module 36 has accepted the HBA information, it advances the processing to the step S106.

Incidentally, the HBA information acquisition module 36 executing the steps S104 and S105 (or the CPU 10e executing the module 36) corresponds to the acquisition means stated before and the acquisition unit stated before. The steps S104 and S105 correspond to the acquisition step stated before.

At the step S106, the HBA information acquisition module 36 executes the optimal HBA information extraction subroutine.

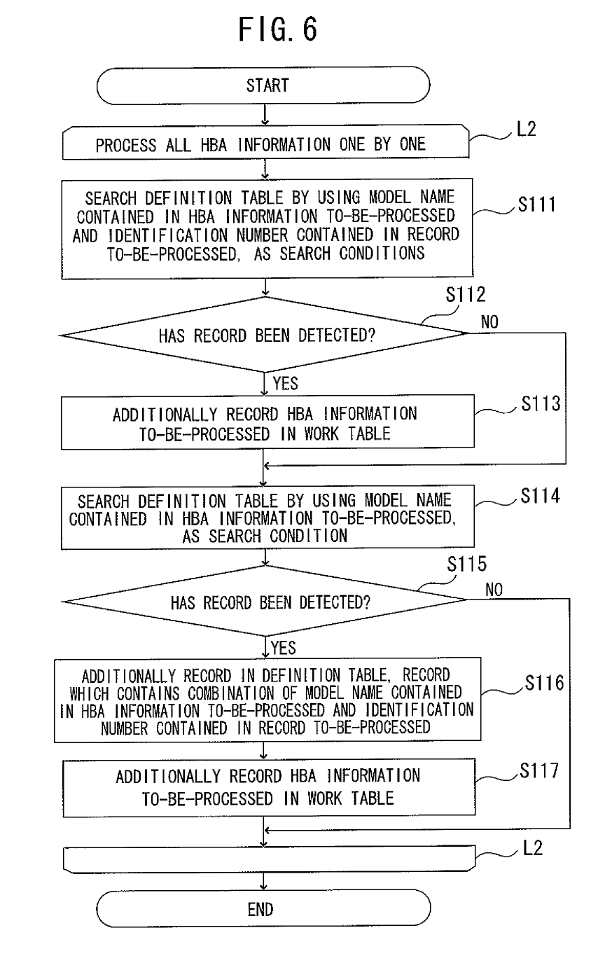

FIG. 6 is a diagram showing the flow of a process based on the optimal HBA information extraction subroutine. As shown in FIG. 6, after the start of the process, the HBA information acquisition module 36 executes the second processing loop L2.

In the second processing loop L2, the HBA information acquisition module 36 executes the processing of steps S111 to S117 for all the HBA information items acquired at the step S105 in FIG. 4, one by one.

At the step S111, the HBA information acquisition module 36 searches the definition table 35 in FIG. 3, by using the model name contained in the HBA information to-be-processed and the identification number contained in the record to-be-processed, as search conditions.

At the next step S112, the HBA information acquisition module 36 discriminates whether or not the record has been detected as the result of the search at the step S111. If the record has not been detected, the HBA information acquisition module 36 branches the processing from the step S112 to the step S114. On the other hand, where the record has been detected, the HBA information acquisition module 36 advances the processing to the step S113.

Incidentally, the HBA information acquisition module 36 executing the steps S111 and S112 (or the CPU 10e executing the module 36) corresponds to the discrimination means described before and the discrimination unit described before. Besides, the steps S111 and S112 correspond to the discrimination step described before.

At the step S113, the HBA information acquisition module 36 additionally records the HBA information to-be-processed in the work table 37 in FIG. 5, whereupon it advances the processing to step S114.

Incidentally, the HBA information acquisition module 36 executing the step S113 (or the CPU 10e executing the module 36) corresponds to the retention means described before and the retention unit described before. The step S113 corresponds to the retention step described before.

At step S114, the HBA information acquisition module 36 searches the definition table 35 in FIG. 3, by using the model name contained in the HBA information to-be-processed, as a search condition.

At the next step S115, the HBA information acquisition module 36 discriminates whether or not the record has been detected as the result of the search at the step S114. If the record has not been detected, the HBA information acquisition module 36 branches the processing from the step S115, and it ends the execution of the second processing loop L2 for the HBA information to-be-processed. On the other hand, where the record has been detected, the HBA information acquisition module 36 advances the processing to step S116.

At the step S116, the HBA information acquisition module 36 additionally records a record which contains the model name contained in the HBA information to-be-processed and the identification number contained in the record to-be-processed, in the definition table 35 in FIG. 3.

At the next step S117, the HBA information acquisition module 36 additionally records the HBA information to-be-processed in the work table 37 in FIG. 5, whereupon it ends the execution of the second processing loop L2 for the HBA information to-be-processed.

After the HBA information acquisition module 36 has executed the processing of the steps S111 to S117 for all the HBA information items acquired at the step S105 in FIG. 4, it departs from the second processing loop L2 and ends the optimal HBA information extraction subroutine according to FIG. 6, whereupon it advances the processing to the step S107 in FIG. 4.

At the step S107, the HBA information acquisition module 36 unloads the common library 33 pertinent to the record to-be-processed. Thereafter, it ends the execution of the first processing loop L1 for the record to-be-processed.

Incidentally, the HBA information acquisition module 36 executing the steps S103 and S107 (or the CPU 10e executing the module 36) corresponds to the switch means described before and the switch unit described before. The steps S103 and S107 correspond to the switch step described before.

After the HBA information acquisition module 36 has executed the processing of the steps S103 to S107 for all the records in the common library management table 34 read out at the step S102, it departs from the first processing loop L1 and advances the process to a step S108.

At the step S108, the HBA information acquisition module 36 transmits the HBA information recorded in the work table 37 in FIG. 5, to the SAN management manager 30b (refer to FIG. 7). Thereafter, the HBA information acquisition module 36 ends the process according to FIG. 4.

Incidentally, the HBA information acquisition module 36 executing the step S108 (or the CPU 10e executing the module 36) corresponds to the transmission means described before and the transmission unit described before. The step S108 corresponds to the transmission step described before.

The job server machine 10 of this embodiment is configured as described above. Therefore, when a request for the HBA information has been made by the SAN management manager 30b, the HBA information acquisition module 36 first loads the individual common libraries 33 in succession in order that any of the plurality of common libraries 33 mounted in the job server machine 10 may be loaded without fail (steps S103 and S107). Besides, the HBA information acquisition module 36 invokes the function “HBA_GetAdapterAttributes( )” within one common library 33 loaded in the memory unit 10f, thereby to acquire the HBA information from all the specific libraries 32 (steps S104 and S105). In addition, when the HBA information acquisition module 36 has acquired a few HBA information items, it determines whether or not the combination of the model name contained in the HBA information and the identification number of the common library 33 loaded at the acquisition of the HBA information is defined in the definition table 35, as to each of the HBA information items. In a case where the combination is defined, the HBA information acquisition module 36 transmits the HBA information to the SAN management manager 30b (steps S106, S111 to S113, and S108).

Owing to such an operation of the HBA information acquisition module 36, even in a case where the job server machine 10 is fixed to one common library 33 and where the HBA information of any HBA 10a sometimes fails to be acquired on account of the inferior combination of the common library 33 and the specific library 32, the HBA information of the HBA 10a can be acquired from the specific library 32 through another common library 33.

Besides, in a case where the HBA information acquisition module 36 has acquired the HBA information through any specific library 32 during the load of any common library 33 and where a model name contained in the HBA information is not registered in the definition table 35 yet, the HBA information acquisition module 36 registers the combination of the model name and the identification number of the common library 33 being loaded, in the definition table 35 (steps S114 to S117). Therefore, in a case where a new HBA 10a has been attached to the job server machine 10, the optimal common library 33 for acquiring the HBA information of the HBA 10a is automatically defined in the definition table 35.

What is claimed is:

1. A storage medium bearing a program which controls
a plurality of HBA drivers for controlling operations of a plurality of HBAs connected to a few storage devices through SAN,
a plurality of specific libraries in an SNIA HBA API, each having a function of acquiring information on the HBA, from the HBA driver as HBA information, and
a common library in the SNIA HBA API, having a function of acquiring HBA information from the respective specific libraries, thereby to acquire the HBA information items and to provide them to a SAN management manager;
the program causing a computer to function as:
storage means for storing records in each of which model identification information specifying a model and common library identification information specifying the common library suited to acquire the HBA information from the HBA of the model are associated, in a definition table for respective models of the HBAs;
switch means for loading any common library into a memory and switching common libraries loaded in the memory, in succession one by one, when a predetermined instruction has been received from the SAN management manager through a communication device;
acquisition means for requesting all the specific libraries to send the HBA information and acquiring the HBA information from the few specific libraries, each time the switch means has loaded one common library into the memory;
discrimination means for discriminating whether or not the record which contains a combination of the model information contained in the HBA information and the common library identification information of the common library in the memory is recorded in the definition table, for every acquired HBA information when the acquisition means has acquired the HBA information;
retention means for retaining the HBA information relevant to the combination, in a predetermined area of the memory in a case where the discrimination means has discriminated that the record containing the combination is recorded in the definition table; and
transmission means for transmitting all the HBA information items which the retention means has retained in the predetermined area, to the SAN management manager through the communication device.

2. A storage medium bearing an HBA information provision program as defined in claim 1, wherein the computer is further caused to function as:
second discrimination means for discriminating whether or not the model information contained in the HBA information is registered in the definition table, for every acquired HBA information when the acquisition means has acquired the HBA information; and
registration means for registering a record in which the model information and the common library identification information of the common library being loaded into the memory are associated, anew in the definition table in a case where the second discrimination means has discriminated that the model information is not registered in the definition table.

3. An HBA information provision program as defined in claim 1, wherein the acquisition means requests all the specific libraries to send the HBA information and acquires the HBA information from the few specific libraries, by invoking a function “HBA_GetAdapterAttributes( )” within the common library loaded in the memory.

4. An HBA information provision program as defined in claim 1, wherein the computer is further caused to function as second storage means for storing a record in which the common library identification information of the common library and positional information specifying a storage location of the common library are associated, in a common library management table every common library;
wherein the switch means selects the common library identification information items within the common library management table, in succession one by one, and when the switch means has selected any common library identification information, the common library in the memory is unloaded, and the common library specified by the positional information corresponding to the selected common library identification information is loaded into the memory.

5. A method for controlling a plurality of HBA drivers, the HBA drivers controlling operations of a plurality of HBAs connected to a few storage devices through a SAN, a plurality of specific libraries in an SNIA HBA API, each having a function of acquiring information on the corresponding HBA, from the corresponding HBA driver as HBA information, and a common library in the SNIA HBA API, having a function of acquiring HBA information from the respective specific libraries, thereby to acquire the HBA information items and to provide them to a SAN management manager;
the method causing a computer to execute:
a storage step of storing records in each of which model identification information specifying a model and common library identification information specifying the common library suited to acquire the HBA information from the HBA of the model are associated, in a definition table for respective models of the HBAs;
a switch step of loading any common library into a memory and switching common libraries loaded in the memory, in succession one by one, when a predetermined instruction has been received from the SAN management manager through a communication device;
an acquisition step of requesting all the specific libraries to send the HBA information and acquiring the HBA information from the few specific libraries, each time one common library has been loaded into the memory at the switch step;
a discrimination step of discriminating whether or not the record which contains a combination of the model information contained in the HBA information and the common library identification information of the common library in the memory is recorded in the definition table, for every acquired HBA information when the HBA information has been acquired at the acquisition step;
a retention step of retaining the HBA information relevant to the combination, in a predetermined area of the memory in a case where it has been determined at the discrimination step that the record containing the combination is recorded in the definition table; and
a transmission step of transmitting all the HBA information items which have been retained in the predetermined area at the retention step, to the SAN management manager through the communication device.

6. An apparatus for controlling a plurality of HBA drivers for controlling operations of a plurality of HBAs connected to a few storage devices through a SAN, a plurality of specific libraries in an SNIA HBA API, each having a function of acquiring information on the corresponding HBA, from the corresponding HBA driver as HBA information, and a common library in the SNIA HBA API, having a function of acquiring HBA information from the respective specific libraries, thereby to acquire the HBA information items and to provide them to a SAN management manager, comprising:
a storage unit for storing records in each of which model identification information specifying a model and common library identification information specifying the common library suited to acquire the HBA information from the HBA of the model are associated, in a definition table for respective models of the HBAs;
a switch unit for loading any common library into a memory and switching common libraries loaded in the memory, in succession one by one, when a predetermined instruction has been received from the SAN management manager through a communication device;
an acquisition unit for requesting all the specific libraries to send the HBA information and acquiring the HBA information from the few specific libraries, each time the switch means has loaded one common library into the memory;
a discrimination unit for discriminating whether or not the record which contains a combination of the model information contained in the HBA information and the common library identification information of the common library in the memory is recorded in the definition table, for every acquired HBA information when the acquisition means has acquired the HBA information;
a retention unit for retaining the HBA information relevant to the combination, in a predetermined area of the memory in a case where the discrimination means has discriminated that the record containing the combination is recorded in the definition table; and
a transmission unit for transmitting all the HBA information items which the retention means has retained in the predetermined area, to the SAN management manager through the communication device.
